(19) United States
(12) Patent Application Publication
(10) Pub. No.: US 2009/0136838 A1
(43) Pub. Date: May 28, 2009

(54) LITHIUM-ION SECONDARY BATTERY, ASSEMBLED BATTERY, HYBRID AUTOMOBILE, AND BATTERY SYSTEM

(76) Inventors: Takeshi ABE, Okazaki-shi (JP); Takuichi Arai, Toyota-shi (JP); Tomitaro Hara, Okazaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/271,979

(22) Filed: Nov. 17, 2008

(30) Foreign Application Priority Data
Nov. 23, 2007 (JP) 2007-303812

(51) Int. Cl. H01M 10/02; H01M 4/48; H02J 7/00; H01M 4/52

(52) U.S. Cl. 429/156; 429/221; 429/220; 320/162

(57) ABSTRACT

A lithium-ion secondary battery of this invention has a positive-electrode active material, a negative-electrode active material, and a nonaqueous electrolysis solution. The positive-electrode active material is LiFe_{(1-X)}M_{X}PO₄ (where M represents at least one of Mn, Cr, Co, Cu, Ni, V, Mo, Ti, Zn, Al, Ga, Mg, B and Nb, and where 0≦X≦0.5). Moreover, the nonaqueous electrolysis solution contains an ester solvent.

### INCORPORATION BY REFERENCE

The disclosure of Japanese Patent Application No. 2007-303812 filed on Nov. 23, 2007 including the specification, drawings and abstract is incorporated herein by reference in its entirety.

### BACKGROUND OF THE INVENTION

1. Field of the Invention

This invention relates to a lithium-ion secondary battery, an assembled battery using this lithium-ion secondary battery, a hybrid automobile mounted with this assembled battery, and a battery system.

2. Description of the Related Art

A lithium-ion secondary battery has been attracting attention as a power source for a cellular phone or as a power source for an electric car and hybrid automobile. Recently, a lithium-ion secondary battery having a positive-electrode active material composed of LiMO₂ (where M represents Co, Ni, Mn, V, Al, Mg etc.), a negative-electrode active material composed of graphite and a nonaqueous electrolysis solution composed of Li salt and nonaqueous solvent has been the most popular lithium-ion secondary battery (see, for example, Japanese Patent Application Publication No. 2005-336000 (JP-A-2005-336000), Japanese Patent Application Publication No. 2003-100300 (JP-A-2003-100300), and Japanese Patent Application Publication No. 2003-059489 (JP-A-2003-059489)). One of the advantages of this lithium-ion secondary battery is that it realizes high discharge voltage and high output.

Incidentally, in order to secure sufficient amount of charged electricity and to obtain high output, such a lithium-ion secondary battery that uses LiMO₂ as the positive-electrode active material and graphite as the negative-electrode active material is used, with an upper limit charging voltage set at 4.2 or higher. However, when the upper limit charging voltage is set at 4.2 or higher, oxidative decomposition of the electrolysis solution progresses, which might result in reduction of the life characteristics of the battery. The oxidative decomposition of the electrolysis solution can be prevented by setting the upper limit charging voltage at 4.0 or lower, but in this way sufficient amount of charged electricity cannot be obtained and the output characteristic decreases significantly. Moreover, the lithium-ion secondary batteries disclosed in JP-A-2005-336000, JP-A-2003-100300 and JP-A-2003-059489 could reduce the output characteristics when the temperature is low (especially −20° C. or lower).

On the other hand, Japanese Patent Application Publication No. 2006-172775 (JP-A-2006-172775) discloses a lithium-ion secondary battery of excellent low-temperature output characteristics, which has a nonaqueous electrolysis solution containing, for example, an ester solvent. The nonaqueous electrolysis solution containing an ester solvent, however, easily develops oxidative decomposition particularly due to an increase in the voltage of the battery. JP-A-2006-172775 describes an example in which the upper limit charging voltage is set at 4.1 V, but even at this upper limit charging voltage of 4.1 V the electrolysis solution with the ester solvent develops oxidative decomposition, which might result in significant reduction of the life characteristics of the battery.

### SUMMARY OF THE INVENTION

The invention provides a lithium-ion secondary battery that has excellent low-temperature output characteristics and life characteristics and is capable of securing sufficient amount of charged electricity, an assembled battery that uses such a lithium-ion secondary battery, a hybrid automobile mounted with this assembled battery, and a battery system.

A first aspect of the invention is a lithium-ion secondary battery that has a positive-electrode active material, a negative-electrode active material and a nonaqueous electrolysis solution, wherein the positive-electrode active material is LiFe_{(1-X)}M_{X}PO₄ (where M represents at least one of Mn, Cr, Co, Cu, Ni, V, Mo, Ti, Zn, Al, Ga, Mg, B and Nb, and where 0≦X≦0.5), and the nonaqueous electrolysis solution contains an ester solvent represented by the following formula (1) where R1 represents an alkyl group having 1 to 4 hydrogen atoms or carbon atoms, and R2 an alkyl group having 1 to 4 carbon atoms.

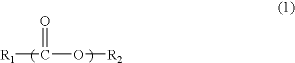

According to the lithium-ion secondary battery of this aspect, the nonaqueous electrolysis solution contains the ester solvent represented by the formula (1). Therefore, excellent low-temperature output characteristics (especially −20° C. or lower) can be achieved. Incidentally, the nonaqueous electrolysis solution containing the ester solvent easily develops oxidative decomposition particularly due to an increase in the voltage of the battery (=positive-electrode potential−negative-electrode potential). Specifically, if the charging voltage is increased to a value at which the positive-electrode potential (based on Li) exceeds 4.05 V, the oxidative decomposition progresses, resulting in significant reduction of the life of the battery.

According to the conventional art, however, in the LiMO₂ (where M represents Co, Ni, Mn, V, Al, Mg etc.) used as the positive-electrode active material, when an upper limit charge potential (based on Li) is set at 4.05 V or lower the amount of Li ion that can be inserted thereto decreases to an amount equivalent to or lower than 85% of a theoretical electric capacity. Moreover, the amount of Li ion to be inserted decreases significantly as the upper limit charge potential (based on Li) is reduced within a range of 4.05 V to 3.55 V. In other words, when the upper limit charge potential (based on Li) is 3.85 V, the amount of Li ion to be inserted decreases to an amount equivalent to approximately 65% of the theoretical electric capacity and, when upper limit charge potential (based on Li) is 3.55 V, the amount of Li ion to be inserted decreases to an amount equivalent to approximately 10% of the theoretical electric capacity.

On the other hand, the lithium-ion secondary battery of this aspect uses LiFe_{(1-X)}M_{X}PO₄ (where M represents at least one of Mn, Cr, Co, Cu, Ni, V, Mo, Ti, Zn, Al, Ga, Mg, B and Nb, and where 0≦X≦0.5). The compound represented by LiFe_{(1-X)}M_{X}PO₄ has characteristics of being able to insert the Li ion in an amount equivalent to approximately 98% of the theoretical electric capacity until the charge potential (based on Li) reaches 4.05 V.

Furthermore, the compound also has characteristics of increasing the charge potential (based on Li) drastically when the theoretical electric capacity exceeds approximately 95% when the theoretical electric capacity is within a range of approximately 15% to 95%, although the charge potential hardly increases when the theoretical electric capacity is within a range of approximately 15% to approximately 95%. Specifically, the charge potential (based on Li) increases from 3.55 V to 4.05 V when the theoretical electric capacity is within a range of 96% to 98%. Therefore, in the lithium-ion secondary battery of the invention, even if the upper limit charging voltage is reduced when the positive-electrode potential (based on Li) falls within a range of 4.05 V to 3.55 V, the reduction of the charged electricity quantity is extremely small. More specifically, even if the upper limit charging voltage is set at a value at which the positive-electrode potential (based on Li) becomes 3.85 V, approximately 97% of the theoretical electric capacity can be accumulated as the electricity quantity and, when the charging upper limit voltage is set at a value at which the positive-electrode potential (based on Li) becomes 3.55 V, approximately 96% of the theoretical electric capacity can be accumulated as the electricity quantity.

Therefore, according to the lithium-ion secondary battery of this aspect, the oxidative decomposition of the electrolysis solution containing an ester solvent can be prevented by using the upper limit charging voltage, with the positive-electrode potential (based on Li) set at a value of at least 3.55 V but not more than 4.05 V. In addition, sufficient amount of charged electricity can be secured in this lithium-ion secondary battery. As described above, the lithium-ion secondary battery of this invention has excellent low-temperature output characteristics and life characteristics and is capable of securing sufficient amount of charged electricity.

The ester solvent may be at least one type of ester solvent selected from methyl formate, ethyl formate, methyl acetate, ethyl acetate, methyl propionate and ethyl propionate.

The excellent low-temperature output characteristics can be obtained by using at least one type of ester solvent selected from methyl formate, ethyl formate, methyl acetate, ethyl acetate, methyl propionate and ethyl propionate.

Moreover, the negative-electrode active material may be a carbon-based material.

The carbon-based material has characteristics of being able to insert/emit Li ion at an extremely low charge/discharge potential (based on Li). Therefore, the lithium-ion secondary battery of this aspect can charge/discharge at battery voltage approximate to the positive-electrode potential (based on Li). Especially LiFe_{(1-X)}M_{X}PO₄ that is used as the positive-electrode potential has characteristics of being able to insert/emit Li ion in amount equivalent to approximately 80% of the theoretical electric capacity at a relatively high potential of approximately 3.4. Accordingly, the lithium-ion secondary battery of this aspect can stably demonstrate high outputs.

Note that examples of the carbon-based material include a natural graphite-based material, artificial graphite-based material (mesocarbon microbead, etc.), and non-graphitizable carbon material. Of these materials, the natural graphite-based material and artificial graphite-base material each has a narrower distance between crystal layers d, a larger crystallite diameter Lc and thus a smaller change in the charge/discharge potential than the non-graphitizable carbon material. Therefore, at least either the natural graphite-based material or artificial graphite-based material (mesocarbon microbead etc.) may be used as the negative-electrode active material.

Of these materials, the natural graphite-base material has characteristics of being able to insert/emit Li ion in an amount equivalent to approximately 100% of the theoretical electric capacity at a charge/discharge potential (based on Li) of approximately 0.05 V Therefore, when using the natural graphite-based material as the negative-electrode active material, it can charge/discharge electricity in an amount equivalent to approximately 80% of the theoretical electric capacity at a battery voltage of approximately 3.35 V (3.4-0.05). In this case, the battery voltage at which the positive-electrode potential (based on Li) is at least 3.55 V but not more than 4.05 V becomes at least 3.5 V but not more than 4.0 V. Therefore, by setting the upper limit charging voltage at a value of at least 3.5 V but not more than 4.0 V, sufficient amount of charged electricity can be secured while keeping excellent low-temperature output characteristics and life characteristics.

The negative-electrode active material may be a Li₄Ti₅O₁₂-based material.

In this lithium-ion secondary battery, a LiFe_{(1-X)}M_{X}PO₄ is used as the positive-electrode active material and a Li₄Ti₅O₁₂-based material as the negative-electrode active material. In such a lithium-ion secondary battery, electricity can be charged/discharged in an amount equivalent to approximately 80% of the theoretical electric capacity without causing much change in the battery voltage. When the LiFe_{(1-X})M_{X}PO₄ is used as the positive-electrode active material, changes in voltage during electricity charge/discharge can be made smaller by using the Li₄Ti₅O₁₂-based material as the negative-electrode active material instead of a carbon-based material. Therefore, in the lithium-ion secondary battery of this aspect, stable output characteristics (IV characteristics) with small output fluctuation can be demonstrated.

Note that the Li₄Ti₅O₁₂ has characteristics of being able to insert/emit Li ion in an amount equivalent to approximately 100% of the theoretical electric capacity at a charge/discharge potential (based on Li) of approximately 1.5 V. Therefore, when the Li₄Ti₅O₁₂ is used as the negative-electrode active material, electricity can be charged/discharge in an amount corresponding to approximately 80% of the theoretical electric capacity at a battery voltage of approximately 1.9 V (3.4-1.5). In this case, the battery voltage at which the positive-electrode potential (based on Li) is at least 3.55 V but not more than 4.05 V becomes at least 2.05 V but not more than 2.55 V. Therefore, by setting the upper limit charging voltage at a value of at least 2.05 V but not more than 2.55 V, sufficient amount of charged electricity can be secured while keeping excellent low-temperature output characteristics and life characteristics.

A second aspect of the invention relates to an assembled battery in which a plurality of the lithium-ion secondary batteries are electrically connected in series with each other.

The assembled battery of this aspect is an assembled battery in which the plurality of lithium-ion secondary batteries are electrically connected in series with each other. Therefore, by setting the upper limit charging voltage of each of the lithium-ion secondary batteries configuring the assembled battery of this aspect at a value at which the positive-electrode potential (based on Li) becomes at least 3.55 V but not more than 4.05 V, sufficient amount of charged electricity can be secured while keeping excellent low-temperature output characteristics and life characteristics.

A third aspect of the invention relates to a hybrid automobile that is mounted with, as a drive power source, the assembled battery in which the plurality of lithium-ion secondary batteries are electrically connected in series with each other. The lithium-ion secondary batteries each has a positive-electrode active material, a negative-electrode active material and a nonaqueous electrolysis solution, wherein the positive-electrode active material is LiFe_{(1-X)}M_{X}PO₄ (where M represents at least one of Mn, Cr, Co, Cu, Ni, V, Mo, Ti, Zn, Al, Ga, Mg, B and Nb, and where 0≦X≦0.5), and the nonaqueous electrolysis solution contains an ester solvent represented by the following formula (1) where R1 represents an alkyl group having 1 to 4 hydrogen atoms or carbon atoms, and R2 an alkyl group having 1 to 4 carbon atoms.

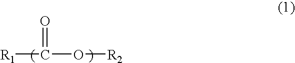

The lithium-ion secondary batteries that configure the assembled battery mounted in the hybrid automobile of this aspect are each a lithium-ion secondary battery that uses LiFe_{(1-X)}M_{X}PO₄ as the positive-electrode active material and the nonaqueous electrolysis solution containing the ester solvent represented by the formula (1) as the nonaqueous electrolysis solution. In this lithium-ion secondary battery, by setting upper limit charging voltage at a value at which the positive-electrode potential (based on Li) is at least 3.55 V but not more than 4.05 V as described above, sufficient amount of charged electricity can be secured while keeping excellent low-temperature output characteristics and life characteristics. Therefore, the hybrid automobile of this invention can demonstrate excellent low-temperature output characteristics (especially −20° C. or lower) over a long period of time. For this reason, the hybrid automobile of the invention can be suitably used in cold climate.

Moreover, in the above-described hybrid automobile, the ester solvent of each lithium-ion secondary battery may be at least one type of ester solvent selected from methyl formate, ethyl formate, methyl acetate, ethyl acetate, methyl propionate and ethyl propionate.

The lithium-ion secondary battery that uses the at least one type of ester solvent selected from methyl formate, ethyl formate, methyl acetate, ethyl acetate, methyl propionate and ethyl propionate can obtain the excellent low-temperature output characteristics. Therefore, the hybrid automobile of this invention can demonstrate excellent low-temperature output characteristics (especially −20° C. or lower) over a long period of time.

In any of the above hybrid automobiles, the negative-electrode active material of the lithium-ion secondary battery may be a carbon-based material.

The lithium-ion secondary batteries that configure the assembled battery mounted in the hybrid automobile of this aspect each use LiFe_{(1-X)}M_{X}PO₄ as the positive-electrode active material and a carbon-based material as the negative-electrode active material. In this lithium-ion secondary battery, electricity can be charged/discharged in an amount equivalent to approximately 80% of the theoretical electric capacity at a battery voltage close to the positive-electrode potential (based on Li), as described above. Therefore, the assembled battery configured by the lithium-ion secondary battery can stably demonstrate high outputs. Accordingly, the hybrid automobile of this aspect can stably demonstrate large drive force.

A fourth aspect of the invention relates to a battery system, which has a lithium-ion secondary battery having a positive-electrode active material, a negative-electrode active material and a nonaqueous electrolysis solution; charge starting means for starting charging the lithium-ion secondary battery; and charge stopping means for stopping charging the lithium-ion secondary battery when an inter-terminal voltage of the lithium-ion secondary battery reaches a predetermined upper limit charging voltage value. In the lithium-ion secondary battery, the positive-electrode active material is LiFe_{(1-X)}M_{X}PO₄ (where M represents at least one of Mn, Cr, Co, Cu, Ni, V, Mo, Ti, Zn, Al, Ga, Mg, B and Nb, and where 0≦X≦0.5), and the nonaqueous electrolysis solution contains an ester solvent represented by the following formula (1) where R1 represents an alkyl group having 1 to 4 hydrogen atoms or carbon atoms, and R2 an alkyl group having 1 to 4 carbon atoms. The charge stopping means may set the upper limit charging voltage value at a value at which a positive-electrode potential based on lithium falls within a range of at least 3.55 V but not more than 4.05 V.

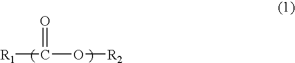

The battery system of this aspect has one or a plurality of lithium-ion secondary batteries; charge starting means for starting charging the lithium-ion secondary batteries; and charge stopping means for stopping charging the lithium-ion secondary batteries when an inter-terminal voltage of each lithium-ion secondary battery reaches a predetermined upper limit charging voltage. The lithium-ion secondary battery uses LiFe_{(1-X)}M_{X}PO₄ as the positive-electrode active material, and a nonaqueous electrolysis solution containing the ester solvent represented by the formula (1) as the nonaqueous electrolysis solution. Furthermore, the charge stopping means sets the upper limit charging voltage value at a value at which the positive-electrode potential based on lithium falls within a range of at least 3.55 V but not more than 4.05 V. Such a battery system can secure sufficient amount of charged electricity while keeping excellent low-temperature output characteristics and life characteristics.

Note that when the battery system of this invention has a plurality of lithium-ion secondary batteries (for example, an assembled battery in which the plurality of lithium-ion secondary batteries are electrically connected in series with each other), for example, the average of inter-terminal voltages of all of the lithium-ion secondary batteries (=output voltage of the assembled battery/the number of electric cells) can be used as the “inter-terminal voltage” as opposed to the upper limit charging voltage. Moreover, an inter-terminal voltage of one lithium-ion secondary battery selected from among the all lithium-ion secondary batteries or the average of inter-terminal voltages of a plurality of lithium-ion secondary batteries selected from among all the lithium-ion secondary batteries can also be used.

The upper limit charging voltage value may be set at a value at which the positive-electrode potential based on lithium falls within a range of at least 3.55 V but not more than 3.85 V.

By setting the upper limit charging voltage value at a small value at which the positive-electrode potential based on lithium falls within a range of at least 3.55 V but not more than 3.85 V, oxidative decomposition of the electrolysis solution containing the ester solvent can be further prevented. In addition, even when the upper limit charging voltage value is set at such a low value, the lithium-ion secondary battery can accumulate electricity in an amount at least 96% of the theoretical electric capacity. Therefore, the battery system of this invention can secure sufficient amount of charged electricity while keeping excellent low-temperature output characteristics and life characteristics.

The ester solvent of the lithium-ion secondary battery may be at least one type of ester solvent selected from methyl formate, ethyl formate, methyl acetate, ethyl acetate, methyl propionate and ethyl propionate.

As described above, the lithium-ion secondary battery that uses the at least one type of ester solvent selected from methyl formate, ethyl formate, methyl acetate, ethyl acetate, methyl propionate and ethyl propionate can achieve the excellent low-temperature output characteristics. Therefore, the battery system of this invention can demonstrate the excellent low-temperature output characteristics (especially −20° C. or lower) over a long period of time.

Furthermore, the negative-electrode active material of the lithium-ion secondary battery, which is a carbon-based material, may set the upper limit charging voltage value to at least 3.5 V but not more than 4.0 V.

The battery system of this aspect uses the lithium-ion secondary battery in which LiFe_{(1-X)}M_{X}PO₄ as the positive-electrode active material and a carbon-based material as the negative-electrode active material. This lithium-ion secondary battery is capable of charging/discharging electricity in an amount equivalent to approximately 80% of the theoretical electric capacity at a battery voltage of approximately 3.4, as described above. In the battery system, on the other hand, the upper limit charging voltage value is set to at least 3.5 V but not more than 4.0 V. As a result, the lithium-ion secondary battery can discharge electricity at a relatively high battery voltage of approximately 3.4 V in a capacity range of up to approximately 80% of the theoretical electric capacity, whereby high outputs can be achieved in a stable manner.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a schematic diagram of a hybrid automobile 1 according to an embodiment;

FIG. 2 is a schematic diagram of a battery system 6 according to the embodiment;

FIG. 3 is a cross-sectional diagram of a lithium-ion secondary battery 100 of the embodiment and a lithium-ion secondary battery 200, 300 of a modified embodiment;

FIG. 4 is a cross-sectional diagram of an electrode body 150 of the embodiment and an electrode body 450 of modified example 3;

FIG. 5 is an enlarged cross-sectional diagram showing the electrode body 150 and the electrode body 450, the view corresponding to an enlarged view of a V part shown in FIG. 4;

FIG. 6 is a charge plot of the lithium-ion secondary battery 100;

FIG. 7 is a discharge plot of the lithium-ion secondary battery 100;

FIG. 8 is a table showing the characteristics of the lithium-ion secondary battery according to an example, comparative example and modified example;

FIG. 9 is a flowchart showing charge control performed by an assembled battery 10;

FIG. 10 is a cross-sectional diagram of a lithium-ion secondary battery 400;

FIG. 11 is a charge plot of the lithium-ion secondary battery 400; and

FIG. 12 is a discharge plot of the lithium-ion secondary battery 400.

### DETAILED DESCRIPTION OF EMBODIMENTS

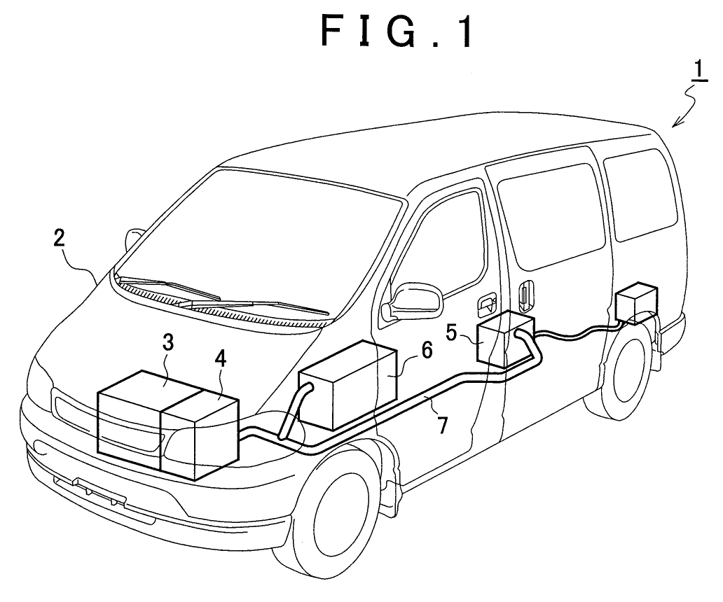

Next, an embodiment of the invention is described with reference to the drawings. A hybrid automobile 1 according to this embodiment has a vehicle body 2, an engine 3, a front motor 4, a rear motor 5, a cable 7 and a battery system 6, as shown in FIG. 1, and is driven by combination use of the engine 3, front motor 4 and rear motor 5. Specifically, the hybrid automobile 1 is configured such that the battery system 6 is used as a drive power source for driving the front motor 4 and the rear motor 5 to cause the hybrid automobile 1 to travel using the engine 3, front motor 4 and rear motor 5 by conventional means.

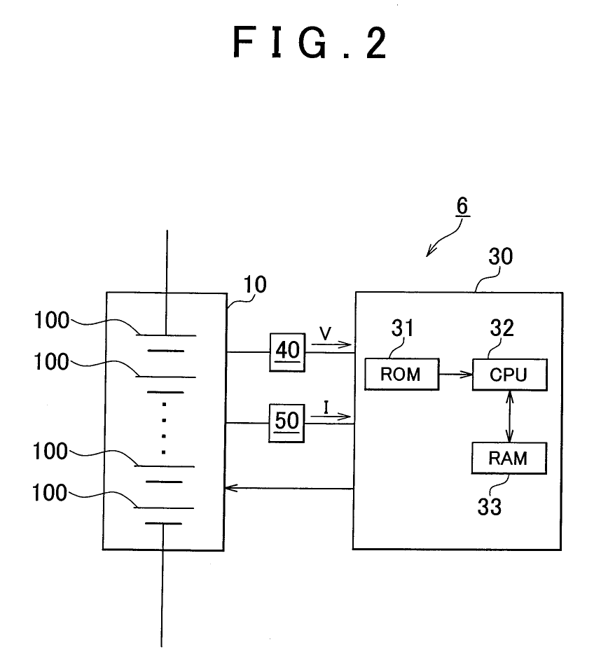

The battery system 6 is attached to the vehicle body 2 of the hybrid automobile 1 and connected to the front motor 4 and rear motor 5 by cables 7. The battery system 6 has, as shown in FIG. 2, an assembled battery 10 in which a plurality of lithium-ion secondary batteries 100 (electric cells) are electrically connected in series with each other, voltage detection means 40, current detection means 50, and a battery controller 30. The battery controller 30 has a Read Only Memory (ROM) 31, a Central Processing Unit (CPU) 32, a Random Access Memory (RAM) 33, and the like.

The voltage detection means 40 detects an inter-terminal voltage V of each lithium-ion secondary battery 100. The current detection means 50 detects the value of current I flowing in the lithium-ion secondary batteries 100 configuring the assembled battery 10.

The battery controller 30 controls charging/discharging of each lithium-ion secondary battery 100 on the basis of the inter-terminal voltage V detected by the voltage detection means 40. Specifically, the battery controller 30 performs control to start charging the lithium-ion secondary battery 100 configuring the assembled battery 10 at predetermined timing. The battery controller 30 further calculates an average value of the inter-terminal voltage V detected by the voltage detection means 40 (average inter-terminal voltage Va) and, when the average inter-terminal voltage Va reaches a predetermined upper limit charging voltage value Vmax, performs control to stop charging the lithium-ion secondary battery 100 configuring the assembled battery 10. The battery controller 30 also integrates the current value I detected by the current detection means 50, to calculate charged electricity quantity or discharged electricity quantity of the lithium-ion secondary battery 100, and then estimates the volume of electricity accumulated in the lithium-ion secondary battery 100 on the basis of the calculated charged electricity quantity or discharged electricity quantity.

Note in the battery system 6 of this embodiment that the upper limit charging voltage value Vmax is set at a value at which a positive-electrode potential based on lithium falls within a range of at least 3.55 V but not more than 4.05 V (3.5 V≦Vmax≦4.0 V in this embodiment). Specifically, the upper limit charging voltage Vmax is set at a value at which the positive-electrode potential based on lithium becomes 3.85 V (Vmax=3.8 V in this embodiment), and this value is stored in the ROM 31 of the battery controller 30. In this embodiment, the battery controller 30 corresponds to the charge starting means and the charge stopping means.

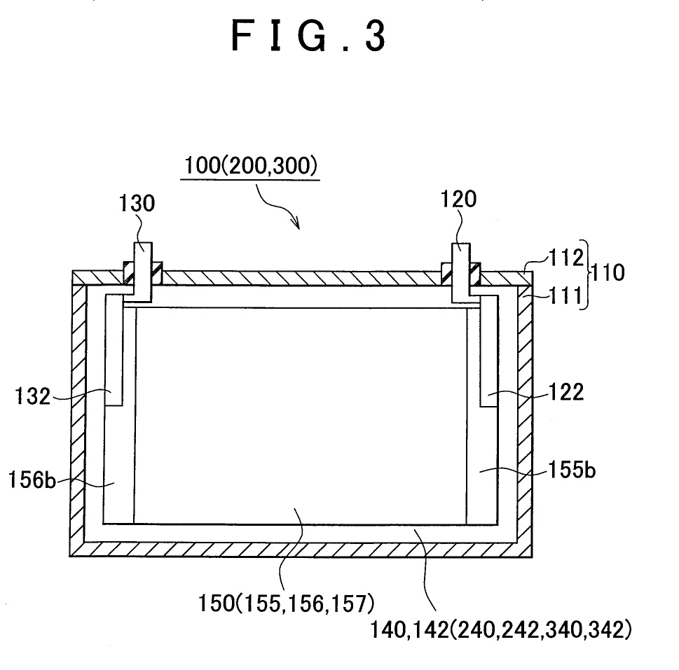

The lithium-ion secondary battery 100 is a square-sealed lithium-ion secondary battery that has a rectangular solid shape battery case 110, a positive-electrode terminal 120, and a negative-electrode terminal 130, as shown in FIG. 3. The battery case 110 has a metallic square container 111 forming a rectangular solid shape containing space, and a metallic lid part 112. An electrode body 150, a positive-electrode current collecting member 122, a negative-electrode current collecting member 132, a nonaqueous electrolysis solution 140 and the like are accommodated in the battery case 110 (square container 111).

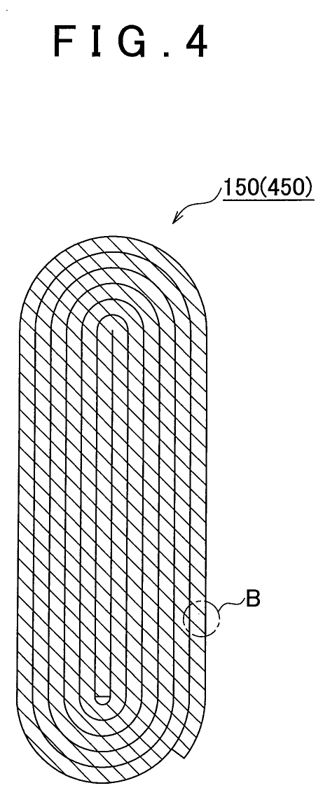

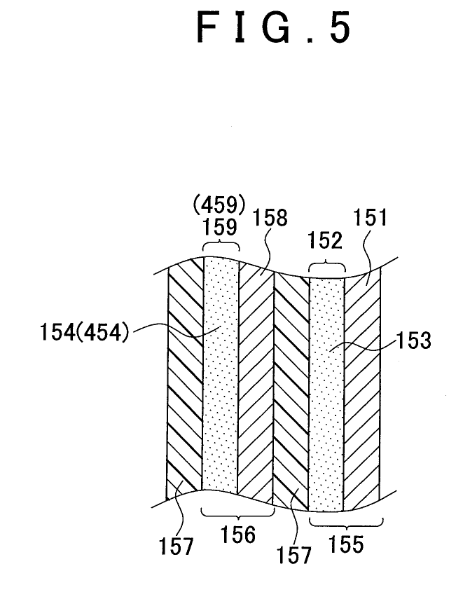

The electrode body 150 is a flat rolled body having an oblong cross section, as shown in FIG. 4, and configured by coiling a sheet-like positive-electrode plate 155, a negative-electrode plate 156 and a separator 157, as shown in FIG. 5. This electrode body 150 has a positive-electrode rolled part 155b which is positioned on one end (right-side end in FIG. 3) of the electrode body 150 in its axial direction (horizontal direction in FIG. 3) and in which only a part of the positive-electrode plate 155 is layered in a spiral manner, and a negative-electrode rolled part 156b which is positioned on the other end (left-side end in FIG. 3) and in which only a part of the negative-electrode plate 156 is layered in a spiral manner. A positive-electrode mixture 152 containing a positive-electrode active material 153 is applied to the positive-electrode plate 155 except the positive-electrode rolled part 155b (see FIG. 5). Similarly, a negative-electrode mixture 159 containing a negative-electrode active material 154 is applied to the negative-electrode plate 156 except the negative-electrode rolled part 156b (see FIG. 5). The positive-electrode rolled part 155b is electrically connected to the positive-electrode terminal 120 via the positive-electrode current collecting member 122. The negative-electrode rolled part 156b is electrically connected to the negative-electrode terminal 130 via the negative-electrode current collecting member 132.

In the lithium-ion secondary battery 100 of this embodiment, LiFePO₄ is used as the positive-electrode active material 153. Also, a natural graphite-based carbon material is used as the negative-electrode active material 154. More specifically, a natural graphite-based material having an average particle diameter of 20 μm, a lattice constant C0 of 0.67 nm, a crystallite diameter Lc of 27 nm, and a graphitization degree of at least 0.9 is used. This negative-electrode active material 154 has characteristics of being able to insert/emit Li ion in an amount equivalent to approximately 100% of theoretical electric capacity at a charge/discharge potential (based on Li) of approximately 0.05 V.

Furthermore, in the lithium-ion secondary battery 100 of this embodiment, a nonaqueous electrolysis solution that is obtained by dissolving 1 mol of lithium hexafluorophosphate (LiPF₆) in a nonaqueous solvent having a mixture of ethylene carbonate (EC), diethyl carbonate (DEC) and methyl acetate (ester solvent 142) mixed at a ratio of 3:4:3 (volume ratio) is used as the nonaqueous electrolysis solution 140. Because the methyl acetate (ester solvent 142) is mixed in a nonaqueous solvent in the lithium-ion secondary battery 100 as described above, excellent low-temperature output characteristics (especially −20° C. or lower) can be achieved. Note that the theoretical electric capacity of the lithium-ion secondary battery 100 is approximately 2.2 Ah.

The methyl acetate is an ester solvent represented by the following formula (2), wherein CH₃ corresponds to R1 and R2 of the formula (1).

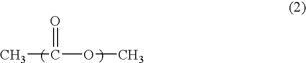

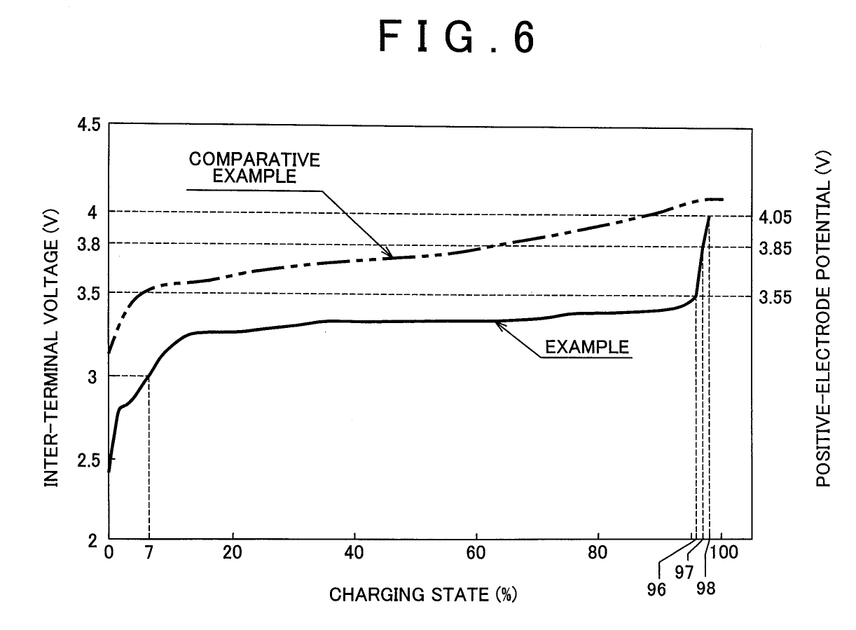

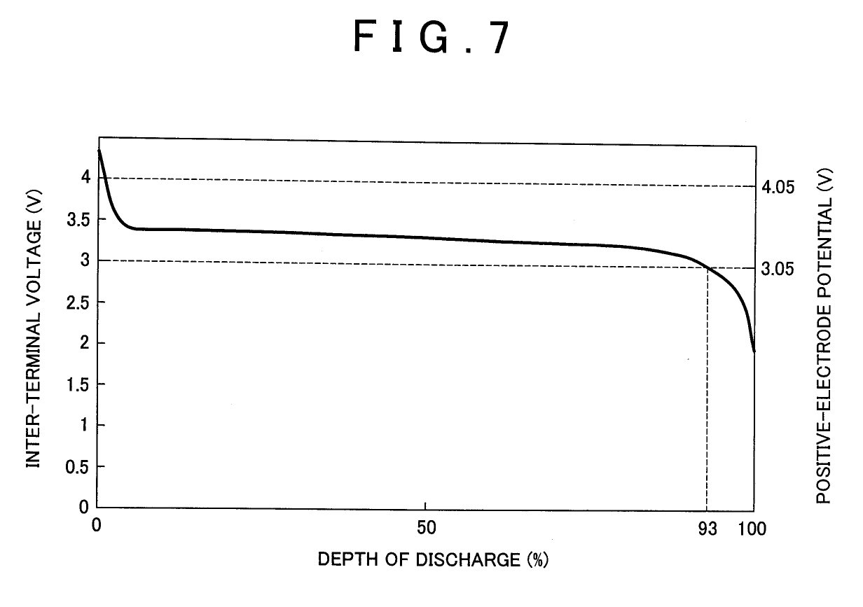

FIGS. 6 and 7 show charge plot and discharge plot of the lithium-ion secondary battery 100, respectively. In FIG. 6, the solid line (example) shows how the inter-terminal voltage between the positive-electrode terminal 120 and the negative-electrode terminal 130 fluctuates when the lithium-ion secondary battery 100 is charged at a current of 1 C. Also, in FIG. 6, the two-dot chain line (comparative example) shows how the inter-terminal voltage fluctuates when a lithium-ion secondary battery (comparative example) is charged at a current of 1 C, the lithium-ion secondary battery being different from the lithium-ion secondary battery 100 in that the positive-electrode active material is changed to LiCoO₂. FIG. 7 shows how the inter-terminal voltage between the positive-electrode terminal 120 and the negative-electrode terminal 130 fluctuates when the lithium-ion secondary battery 100 is charged at a current of 1 C. Note that the current value 1 C is a current value at which the theoretical electric capacity can be charged for one hour so that the positive-electrode active material 153 (LiFePO₄) contained in the lithium-ion secondary battery 100 can be theoretically accumulated to the maximum possible level.

As shown in FIG. 6, in the lithium-ion secondary battery 100, electricity can be charged in an amount equivalent to approximately 98% of the theoretical electric capacity until the inter-terminal voltage becomes 4.0 V. Here, since positive-electrode potential (based on Li)=battery voltage+negative-electrode potential (based on Li) is established, the positive-electrode potential (based on Li)=battery voltage+0.05 (V) in the lithium-ion secondary battery 100. Therefore, as shown in FIG. 6, in the lithium-ion secondary battery 100, electricity quantity equivalent to approximately 98% of the theoretical electric capacity can be accumulated until the positive-electrode potential (based on Li) becomes 4.05 V. Moreover, although the positive-electrode potential (based on Li) increases very little within the theoretical electric capacity range of approximately 15% to approximately 95%, the positive-electrode potential drastically increases when the theoretical electric capacity exceeds approximately 95%. Specifically, the positive-electrode potential (based on Li) increases from 3.55 V to 4.05 V within the theoretical electric capacity range of 96% to 98%.

The reason is that the LiFe_{(1-X)}M_{X}PO₄, the positive-electrode active material 153, has characteristics of being able to insert Li ion in an amount equivalent to approximately 98% of the theoretical electric capacity until the charge potential (based on Li) becomes 4.05 V. Another reason is that although the charge potential (based on Li) increases very little within the theoretical electric capacity range of approximately 15% to approximately 95%, the charge potential drastically increases when the theoretical electric capacity exceeds approximately 95%.

Therefore, in the lithium-ion secondary battery 100, electricity quantity equivalent to at least approximately 96% of the theoretical electric capacity can be accumulated by setting the upper limit charging voltage at a value at which the positive-electrode potential (based on Li) becomes at least 3.55 V but not more than 4.05 V and by charging the battery until the battery voltage reaches the upper limit charging voltage. More specifically, when the upper limit charging voltage is set at a value (i.e., 4.0 V) at which the positive-electrode potential (based on Li) becomes 4.05 V, the electricity quantity equivalent to approximately 98% of the theoretical electric capacity can be accumulated. Furthermore, the electricity quantity equivalent to approximately 98% of the theoretical electric capacity by setting the upper limit charging voltage at a value (i.e., 3.8 V) at which the positive-electrode potential (based on Li) becomes 3.85 V, and the electricity quantity equivalent to approximately 96% of the theoretical electric capacity can be accumulated even when the upper limit charge potential (based on Li) is reduced to 3.55 V.

In the lithium-ion secondary battery 100, because the nonaqueous electrolysis solution 140 contains the ester solvent 142 (methyl acetate), the excellent low-temperature output characteristics (especially −20° C. or lower) can be achieved.

Incidentally, the nonaqueous electrolysis solution containing the ester solvent is oxidatively decomposed easily as, especially, the battery voltage (=positive-electrode potential−negative-electrode potential) increases. Specifically, if the battery voltage is increased to a value at which the positive-electrode potential (based on Li) exceeds 4.05 V, the oxidative decomposition progresses, resulting in significant reduction of the life of the battery.

However, in the lithium-ion secondary battery of the comparative example (the positive-electrode active material thereof is LiCoO₂), when the upper limit charging voltage is set at a value (4.0 V) at which the positive-electrode potential (based on Li) becomes 4.05 V or lower to perform charging, the electricity quantity equivalent to only 85% or lower of the theoretical electric capacity is accumulated. Moreover, the electricity quantity to be accumulated is reduced significantly as the upper limit charging voltage is reduced in a range of 4.05 V to 3.55 V where the positive-electrode potential (based on Li) falls. Specifically, when the upper limit charging voltage is set at a value (3.8 V) at which the positive-electrode potential (based on Li) becomes 3.85 V and the battery is charged, the electricity quantity equivalent to only approximately 65% of the theoretical electric capacity is accumulated. When the upper limit charging voltage is set at a value (3.5 V) at which the positive-electrode potential (based on Li) becomes 3.55 V, the electricity quantity equivalent to only approximately 5% of the theoretical electric capacity is accumulated. Therefore, in the lithium-ion secondary battery of the comparative example (the positive-electrode active material thereof is LiCoO₂), when the upper limit charging voltage is set at 4.05 V or lower in order to prevent the oxidative decomposition of the nonaqueous electrolysis solution containing the ester solvent, sufficient amount of charged electricity cannot be secured.

In the lithium-ion secondary battery 100 of this embodiment, on the other hand, sufficient amount of charged electricity (at least 96% of the theoretical electric capacity) can be secured even when the upper limit charging voltage is set at a value at which the positive-electrode potential (based on Li) becomes at least 3.55 V but not more than 4.05 V, as described above. By setting the upper limit charging voltage at a low value at which the positive-electrode potential (based on Li) becomes 4.05 V or lower, the nonaqueous electrolysis solution 140 containing the ester solvent 142 from being oxidatively decomposed. Therefore, life characteristics of the battery can be improved.

Therefore, in the lithium-ion secondary battery 100 the nonaqueous electrolysis solution 140 containing the ester solvent 142 can be prevented from being oxidatively decomposed and sufficient amount of charged electricity can be secured, by setting the upper limit charging voltage at a value at which the positive-electrode potential (based on Li) becomes at least 3.55 V but not more than 4.05 V. Particularly, by setting the upper limit charging voltage at a value at which the positive-electrode potential (based on Li) becomes at least 3.55 V but not more than 3.85 V, sufficient amount of charged electricity can be secured and the nonaqueous electrolysis solution 140 containing the ester solvent 142 can be further prevented from being oxidatively decomposed. As described above, the lithium-ion secondary battery 100 of this embodiment can secure sufficient amount of charged electricity while improving the low-temperature output characteristics and life characteristics of the battery.

Also, as shown in FIG. 7, electricity can be discharged in an amount equivalent to approximately 80% of the theoretical electric capacity (in a depth-of-discharge range of approximately 5 to 85%) at a battery voltage of approximately 3.35 V (=3.4-0.05). The reason is that the LiFe_{(1-X)}M_{X}PO₄, the positive-electrode active material 153, has characteristics of being able to insert/emit Li-ion in an amount equivalent to approximately 80% of the theoretical electric capacity at a relatively high potential of approximately 3.4, and that the natural graphite-based material, which is the negative-electrode active material 154, has characteristics of being able to insert/emit Li ion in an amount equivalent to approximately 100% of the theoretical electric capacity at a charge/discharge potential (based on Li) of approximately 0.05 V. Therefore, because electricity can be discharged at a relatively high battery voltage of approximately 3.35 V in a theoretical electric capacity range of approximately 80%, the lithium-ion secondary battery 100 can stably demonstrate high outputs.

Next, a method for producing the lithium-ion secondary battery 100 of this embodiment is described. First, LiFePO₄ (positive-electrode active material 153), acetylene black (conducting assistant) and polyvinylidene-fluoride (binder resin) were mixed at a ratio of 85:5:10 (volume ratio) and then N-methylpyrrolidone (dispersion solvent) was mixed into this mixture to prepare a positive-electrode slurry. Next, this positive-electrode slurry was applied to a surface of an aluminum foil 151, which is then dried and pressed. As a result, the positive-electrode plate 155 having the positive-electrode mixture 152 applied onto the aluminum foil 151 was obtained (see FIG. 5).

Furthermore, the natural graphite-based carbon material (negative-electrode active material 154), styrene-butadiane copolymer (binder resin) and carboxymethyl cellulose (thickener) were mixed in water at a ratio of 95:2.5:2.5 (volume ratio) to prepare a negative-electrode slurry. Next, this negative-electrode slurry was applied to a surface of a copper foil 158, which is then dried and pressed. As a result, the negative-electrode plate 156 having the negative-electrode mixture 159 applied on the surface of the copper foil 158 was obtained (see FIG. 5). In this embodiment, a natural graphite-based material having an average particle diameter of 20 μm, a lattice constant CO of 0.67 nm, a crystallite diameter Lc of 27 nm, and a graphitization degree of at least 0.9 is used as the natural graphite-based carbon material. Note that in this embodiment the amount of application of the positive-electrode slurry and the negative-electrode slurry is adjusted so that the ratio between the positive electrode theoretical capacity and the negative electrode theoretical capacity becomes 1:1.5.

Next, the positive-electrode plate 155, the negative-electrode plate 156 and the separator 157 are stacked and rolled to form the electrode body 150 having an elliptic cross-sectional shape (see FIGS. 4 and 5). However, when stacking the positive-electrode plate 155, the negative-electrode plate 156 and the separator 157, the positive-electrode plate 155 is disposed such that an unapplied part of the positive-electrode plate 155 to which the positive-electrode mixture 152 is not applied protrudes from one end of the electrode body 150. Furthermore, the negative-electrode plate 156 is disposed such that an unapplied part of the negative-electrode plate 156 to which the negative-electrode mixture 159 is not applied protrudes from the opposite side of the unapplied part of the positive-electrode plate 155. In this manner, the electrode body 150 with the positive-electrode rolled part 155b and the negative-electrode rolled part 156b is formed (see FIG. 3). Note that in this embodiment a polypropylene/polyethylene composite porous membrane is used as the separator 157.

Next, the positive-electrode rolled part 155b of the electrode body 150 and the positive-electrode terminal 120 are connected with each other via the positive-electrode current collecting member 122. Also, the negative-electrode rolled part 156b of the electrode body 150 and the negative-electrode terminal 130 are connected with each other via the negative-electrode current collecting member 132. Thereafter, thus obtained product is placed into the metallic square container 111 and the metallic square container 111 and the lid part 112 are welded together to seal the battery case 110. Next, the nonaqueous electrolysis solution 140 was injected through an injection inlet (not shown) provided on the lid part 112 and then the injection inlet is sealed, whereby the lithium-ion secondary battery 100 of this embodiment is completed. Note that in this embodiment a nonaqueous electrolysis solution that is obtained by dissolving 1 mol of lithium hexafluorophosphate (LiPF₆) in a solvent having a mixture of EC, DEC and methyl acetate (ester solvent 142) mixed at a ratio of 3:4:3 (volume ratio) is used as the nonaqueous electrolysis solution 140.

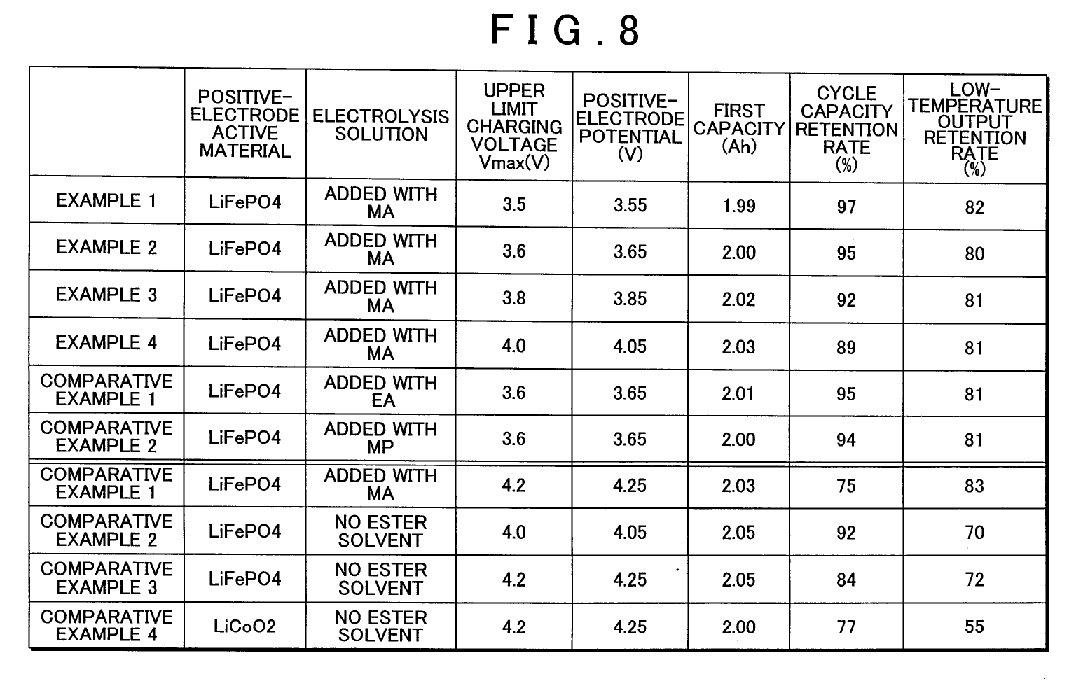

(Measurement of first capacity) Next, for the lithium-ion secondary battery 100, the upper limit charging voltage Vmax was set at different values such as 3.5 V, 3.6 V, 3.8 V and 4.0 V at which the positive-electrode potential (based on Li) becomes 3.55 V, 3.65 V, 3.85 V and 4.05 V respectively, to measure a first capacity for each value in examples 1 to 4. Specifically, first, constant-current charging was performed at a current of ⅕ C until the inter-terminal voltage reaches the upper limit charging voltage Vmax. Thereafter, constant-voltage charging was performed at the upper limit charging voltage Vmax, and the charging was ended when the current value at the time of the charging was reduced to 1/10 of the current value obtained when the constant-voltage charging was started. Next, constant-current discharge was performed at a current of ⅕ C until the inter-terminal voltage reaches 3 V, and thus obtained discharged electricity quantity was obtained as the first capacity. In addition, in comparative example 1, the upper limit charging voltage Vmax was set at 4.2 V, which is a value at which the positive-electrode potential (based on Li) becomes 4.25 V, to measure the first capacity. The results are shown in FIG. 8.

Note that in the lithium-ion secondary battery 100, the natural graphite-based material used as the negative-electrode active material 154 has characteristics of being able to insert/emit Li ion in an amount equivalent to approximately 100% of the theoretical electric capacity at a charge/discharge potential (based on Li) of approximately 0.05 V. Therefore, in this embodiment, the value obtained by adding 0.05 V to the detected inter-terminal voltage V as the positive-electrode potential (V) (see FIG. 8). Also, in FIG. 8 the methyl acetate is denoted as MA, ethyl acetate as EA, and methyl propionate as MP.

As shown in FIG. 8, the first capacities of examples 1 to 4 that are obtained when the upper limit charging voltage Vmax was set at 3.5 V, 3.6 V, 3.8 V and 4.0 V were all approximately 2.0 Ah. In other words, the first capacities were 1.99 Ah, 2.00 Ah, 2.02 Ah, and 2.03 Ah. In comparative example 1, the first capacities that is obtained when the upper limit charging voltage Vmax was 4.2 V was 2.03 Ah, which is the same as the first capacity obtained when the upper limit charging voltage Vmax was 4.0 V. As a result, in the lithium-ion secondary battery 100 sufficient amount of charged electricity can be secured even when the upper limit charging voltage Vmax is set at a low value of 4.0 V or lower.

Moreover, another comparative example has prepared a lithium-ion secondary battery that is different from the lithium-ion secondary battery 100 in that this lithium-ion secondary battery does not contain an ester solvent in the electrolysis solution. Specifically, as the electrolysis solution, the one that is obtained by dissolving 1 mol of lithium hexafluorophosphate (LiPF₆) in a solvent having a mixture of EC and DEC mixed at a ratio of 3:7 (volume ratio) was used. As with the case of the above-described example, for this lithium-ion secondary battery as well, different values for the upper limit charging voltage Vmax such as 4.0 V and 4.2 V were used to measure the first capacity for each value in comparative examples 2 and 3. The results of comparative examples 2 and 3 are shown in FIG. 8.

In addition, comparative example 4 has prepared a lithium-ion secondary battery that is different from the lithium-ion secondary battery 100 in that, in this lithium-ion secondary battery, the positive-electrode active material is changed to LiCoO₂ and the electrolysis solution is changed as with the cases of comparative examples 2 and 3. As with the case of the above-described example, for this lithium-ion secondary battery as well, the upper limit charging voltage Vmax was set at 4.2 V (at which the positive-electrode potential becomes 4.25 V) to measure the first capacity. The result of comparative example 4 is shown in FIG. 8.

The first capacities obtained examples 1 to 4 and the first capacity obtained comparative example 4 were all approximately 2.0 Ah. As a result, even when the upper limit charging voltage Vmax is set at a low value between 3.5 V and 4.0 V (at which the positive-electrode potential based on Li becomes 3.55 V to 4.05 V) and the lithium-ion secondary battery 100 is charged at this voltage, substantially the same electricity quantity can be accumulated as in a case when the upper limit charging voltage Vmax is set at 4.2 V (at which the positive-electrode potential based on Li becomes 4.25 V or lower) to charge the battery in which LiCoO₂ is used as the positive-electrode active material. As described above, in the lithium-ion secondary battery 100, sufficient amount of charged electricity can be secured even when the upper limit charging voltage Vmax is set at least 3.5 V but not more than 4.0, which is a value at which the positive-electrode potential (based on Li) becomes 3.55 V to 4.05 V.

(Low-temperature output test) Next, a low-temperature output test was carried out on the batteries of the abovementioned examples 1 to 4 and comparative examples 1 to 4. Specifically, under a temperature environment of 25° C., constant-current charging was performed at a current of ⅕ C until the inter-terminal voltage reaches each upper limit charging voltage Vmax (see FIG. 8), and thereafter constant-voltage charging was performed at each upper limit charging voltage Vmax. The charging was ended as soon as the current value at the time of the charging is reduced to 1/10 of the current value that is obtained when the constant-voltage charging is started. Next, under a temperature environment of −20° C., constant-current discharge was performed at a current of 1 C until the inter-terminal voltage reaches 3 V. The obtained discharged capacities were measured, and the ratio of each first capacity (25° C.) with respect to each discharged capacity was calculated as a low-temperature output retention rate (%). The results are shown in FIG. 8.

As shown in FIG. 8, in each of the batteries of examples 1 to 4 and comparative example 1, i.e., in the lithium-ion secondary battery 100 in which the nonaqueous electrolysis solution 140 containing the ester solvent 142 (i.e., methyl acetate) is used, the low-temperature output retention rate was as high as at least 80% and the low-temperature output characteristics were improved. On the other hand, in each of the batteries of comparative examples 2 to 4, i.e., the lithium-ion secondary battery in which the electrolysis solution that does not contain an ester solvent is used, the low-temperature output retention rate was 72% or lower and the low-temperature output characteristics were not good. Therefore, excellent low-temperature output characteristics (especially −20° C. or lower) can be obtained by using the electrolysis solution containing an ester solvent (i.e., methyl acetate).

(Cycle test) Moreover, a cycle test was performed on the batteries of the above-described examples 1 to 4 and comparative examples 1 to 4. Specifically, under a temperature environment of 25° C., constant-current charging was performed at a current of 5 C until the inter-terminal voltage reaches each upper limit charging voltage Vmax (see FIG. 8), and thereafter constant-voltage charging was performed at each upper limit charging voltage Vmax. The charging was ended as soon as the current value at the time of the charging is reduced to 1/10 of the current value that is obtained when the constant-voltage charging is started. Next, constant-current discharge was performed at a current of 5 C until the inter-terminal voltage reaches 3 V. This charging/discharging process was taken as 1 cycle, and 500 cycles of this process were performed. At this moment, the discharged capacity obtained at 500^{th} cycle was measured in each example, and a ratio of the first capacity with respect to the each discharged capacity was calculated as a cycle capacity retention rate (%). The results are shown in FIG. 8.

As shown in FIG. 8, in examples 1 to 4, i.e., in the lithium-ion secondary battery 100, when the cycle test was performed with the upper limit charging voltage Vmax set at 3.5 V to 4.0 V (at which the positive-electrode potential based on Li becomes 3.55 V to 4.05 V), the cycle capacity retention rate was as high as 89% to 97% and therefore the life characteristics of each battery were improved. Especially in examples 1 to 3, when the cycle test was performed with the upper limit charging voltage Vmax set at a value at which the positive-electrode potential based on Li becomes 3.55 V to 3.85 V, the cycle capacity retention rate was at least 92%, which showed excellent life characteristics.

On the other hand, in comparative example 1, when the cycle test was performed on the lithium-ion secondary battery 100 with the upper limit charging voltage Vmax set at 4.2 V (at which the positive-electrode potential based on Li becomes 4.25 V), the cycle capacity retention rate was significantly reduced to 75%, and thus the life characteristics of the battery were also significantly reduced. By setting the upper limit charging voltage Vmax at 4.2 V (at which the positive-electrode potential based on Li becomes 4.25 V), it is considered that the oxidative decomposition of the electrolysis solution containing the ester solvent (i.e., methyl acetate) has progressed.

According to the above results, the nonaqueous electrolysis solution 140 containing the ester solvent 142 (i.e., methyl acetate) can be prevented from being oxidatively decomposed and consequently the life characteristics of the battery can be improved by setting the upper limit charging voltage Vmax at a value at which the positive-electrode potential based on Li becomes 4.05 V or lower (preferably 3.85 V). Accordingly, in the lithium-ion secondary battery 100, sufficient amount of charged electricity can be secured while keeping the excellent low-temperature output characteristic and life characteristics, by using the battery at the upper limit charging voltage Vmax set at a value at which the positive-electrode potential based on Li becomes 3.55 V to 4.05 V (preferably 3.55 V to 3.85 V).

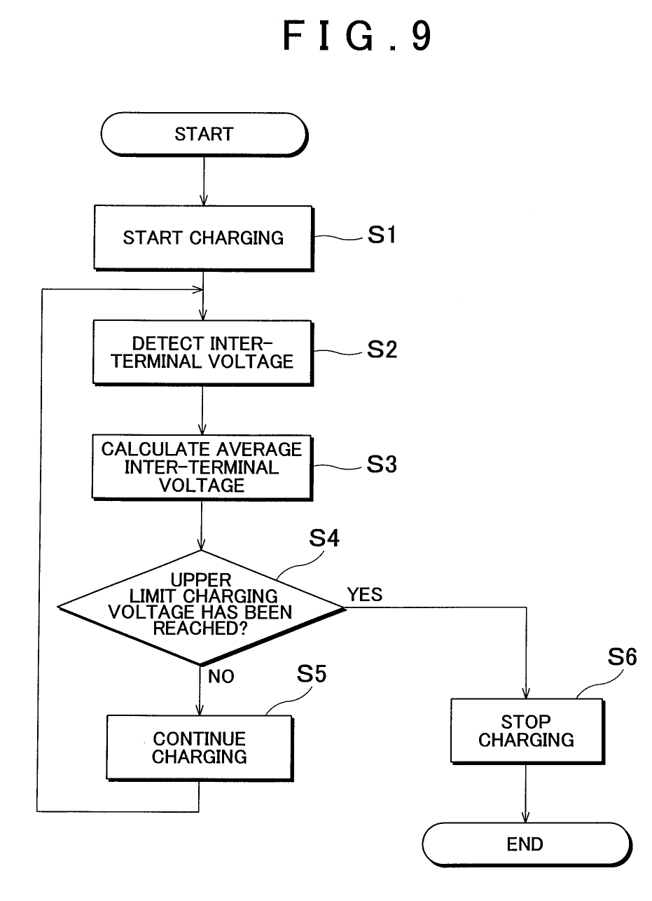

Next, charge control performed by the assembled battery 10 in the battery system 6 of this embodiment is described with reference to FIG. 9. First, in step S1, control performed by the battery controller 30 starts charging the lithium-ion secondary batteries 100 configuring the assembled battery 10. Next, in step S2, the voltage detection means 40 detects the inter-terminal voltage V applied to each lithium-ion secondary battery 100. Thereafter, in step S3, the average value of the inter-terminal voltages V (average inter-terminal voltage Va) applied to the lithium-ion secondary batteries 100 is calculated, the inter-terminal voltages V being detected by the voltage detection means 40. Note that in this embodiment step S1 corresponds to the charge starting means.

Next, in step S4, it is determined whether the average inter-terminal voltage Va reaches the upper limit charging voltage value Vmax. Note that the upper limit charging voltage value Vmax may be set at a value at which the positive-electrode potential based on Li falls within a range of 3.55 V to 4.05 V (within a range of 3.5 V to 4.0 V in this embodiment). The upper limit charging voltage value Vmax can be set at, for example, 3.8 V (at which the positive-electrode potential based on Li becomes 3.85 V). When it is determined in step S4 that the average inter-terminal voltage Va does not reach the upper limit charging voltage value Vmax (No), the process advances to step S5 where the lithium-ion secondary battery 100 is continuously charged. Thereafter, the process returns to step S2 to perform the abovementioned processing again. However, when it is determined in step S4 that the average inter-terminal voltage Va reaches the upper limit charging voltage value Vmax (Yes), the process advances to step S6 where the charging of the lithium-ion secondary battery 100 is stopped. Note that in this embodiment step S6 corresponds to the charge stopping means.

As described above, in the battery system 6 of this embodiment, the upper limit charging voltage value Vmax is set at a value at which the positive-electrode potential based on Li falls within a range of 3.55 V to 4.05 V, to perform the charge control. Sufficient amount of charged electricity can be secured while keeping the excellent low-temperature output characteristics and life characteristics, by controlling the positive-electrode potential (based on Li) to fall within a range of at least 3.55 V but not more than 4.05 V to charge the lithium-ion secondary batteries 100 configuring the assembled battery 10. Particularly, the electrolysis solution containing the ester solvent can be further prevented from being oxidatively decomposed, and consequently the life characteristics of the batteries can be further improved, by performing the charge control with the upper limit charging voltage Vmax set at a value at which the positive-electrode potential based on Li falls within a range of 3.55 V to 3.85 V, that is, by controlling the positive-electrode potential (based on Li) of each lithium-ion secondary battery 100 to not exceed 3.85 V.

(Modification) Next, modifications (modified examples 1 and 2) of the above embodiment are described. The lithium-ion secondary batteries 200, 300 of modified examples 1 and 2 are different from the lithium-ion secondary battery 100 of the above embodiment in terms of the ester solvent contained in the electrolysis solution, but the rest of the configurations of the lithium-ion secondary batteries 200, 300 and the lithium-ion secondary battery 100 are the same (see FIG. 3).

Specifically, in modified example 1, ester acetate is used as the ester solvent. Therefore, an electrolysis solution 240 that is obtained by dissolving 1 mol of lithium hexafluorophosphate (LiPF₆) in a solvent having a mixture of EC, DEC and ethyl acetate (ester solvent 242) mixed at a ratio of 3:4:3 (volume ratio) is used as the electrolysis solution (see FIG. 3). Also, in modified example 2, methyl propylate is used as the ester solvent. Therefore, an electrolysis solution 340 that is obtained by dissolving 1 mol of lithium hexafluorophosphate (LiPF₆) in a solvent having a mixture of EC, DEC and methyl propylate (ester solvent 342) mixed at a ratio of 3:4:3 (volume ratio) is used as the electrolysis solution (see FIG. 3).

As with the case of example 2 above (the upper limit charging voltage Vmax was set at a value at which the positive-electrode potential based on Li becomes 3.65 V), for the lithium-ion secondary batteries 200, 300 of these modified examples 1, 2 as well, the first capacities were obtained and the cycle test and low-temperature output test were performed. The results are shown in FIG. 8. As shown in FIG. 8, for the first capacities, cycle capacity retention rates and low-temperature output retention rates of the batteries of modified examples 1 and 2, the same excellent results as example 2 were obtained. According to these results, sufficient amount of charged electricity can be secured while keeping the excellent low-temperature output characteristics and life characteristics even when methyl acetate or ethyl acetate is used in place of methyl acetate, as the ester solvent of the nonaqueous electrolysis solution.

The above has described the embodiment and modifications, but this invention is not limited to the above embodiment and the like, and therefore various changes may be made within the scope of the invention.

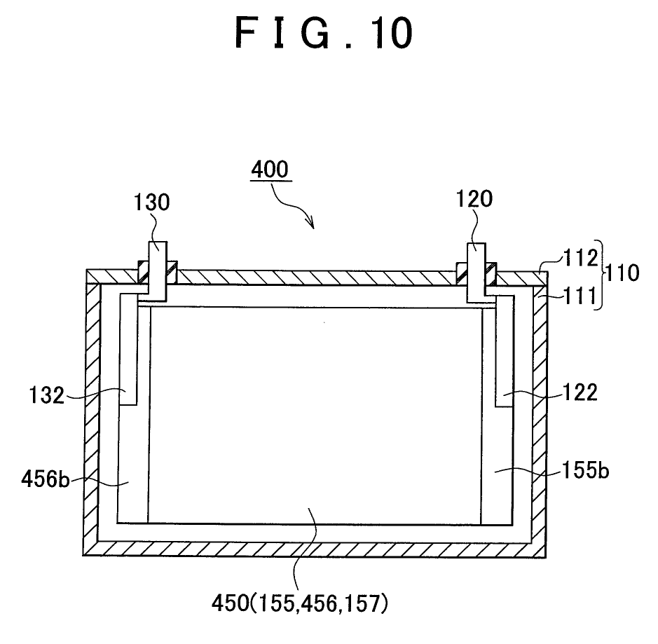

For example, in the embodiment and the like, the carbon-based material (i.e., the natural graphite-based material) is used as the negative-electrode active material, but Li₄Ti₅O₁₂ may be used. Specifically, the effects of the invention can be achieved even when using the lithium-ion secondary battery 400 (modified example 3) that is different from the lithium-ion secondary battery 100 of the above embodiment in that a negative-electrode plate 456 in place of the negative-electrode plate 156, as shown in FIG. 10.

In modified example 3, Li₄Ti₅O₁₂ was used as a negative-electrode active material 454 and a sintered body 459 containing Li₄Ti₅O₁₂ was applied to the surface of the copper foil 158, which is then pressed, to prepare the negative-electrode plate 456 (see FIG. 5). Thereafter, the positive-electrode plate 155, negative-electrode plate 456, and separator 157 were stacked and rolled to form an electrode body 450 having an elliptic cross-sectional shape (see FIGS. 4 and 5). For the rest of the configuration, the same process can be performed as in the case of the lithium-ion secondary battery 100 of the above embodiment, to obtain the lithium-ion secondary battery 400 of this modified example 3.

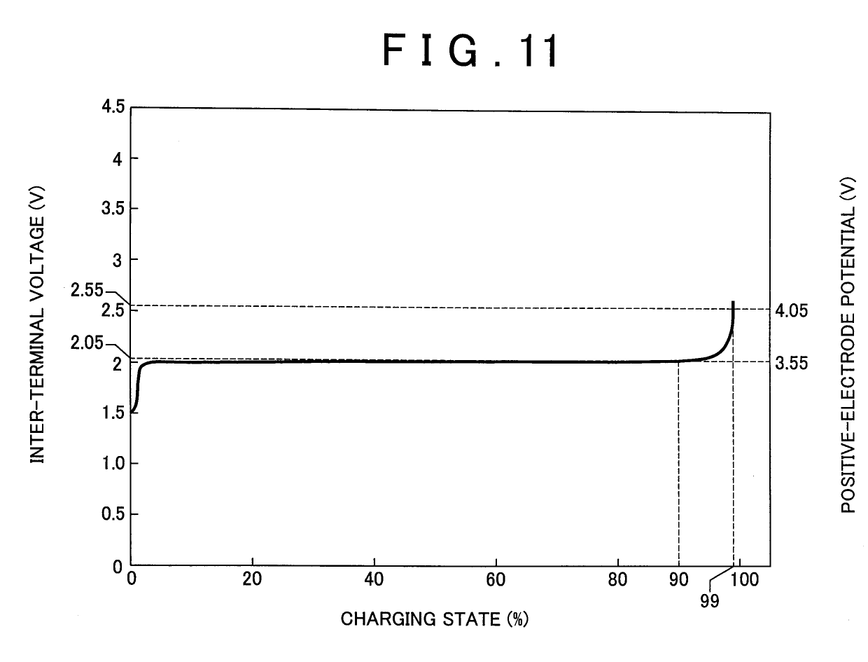

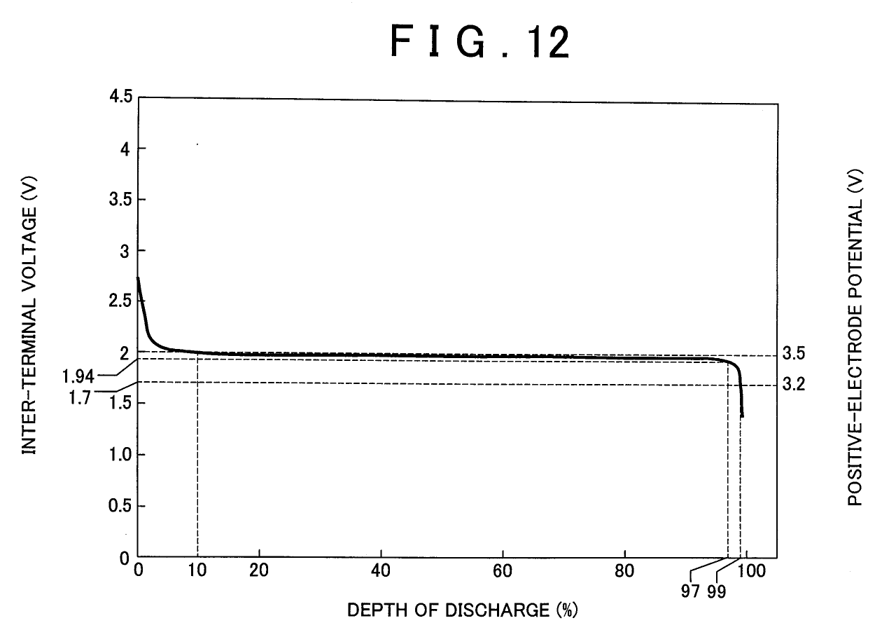

FIGS. 11 and 12 show a charge plot and a discharge plot of the lithium-ion secondary battery 400, respectively. FIG. 11 shows fluctuation in the inter-terminal voltage between the positive-electrode terminal 120 and the negative-electrode terminal 130 that is caused when the lithium-ion secondary battery 400 is charged at a current of 1 C. FIG. 12 shows fluctuation in the inter-terminal voltage between the positive-electrode terminal 120 and the negative-electrode terminal 130 that is caused when the lithium-ion secondary battery 400 is discharged at a current of 1 C. Note that this current value 1 C is a current value at which the theoretical electric capacity can be charged for one hour so that the positive-electrode active material 153 (LiFePO₄) contained in the lithium-ion secondary battery 400 can be theoretically accumulated to the maximum possible level.

As shown in FIGS. 11 and 12, the battery voltage fluctuates very little in the lithium-ion secondary battery 400, and electricity can be charged/discharge in an amount equivalent to at least 80% of the theoretical electric capacity at a battery voltage of approximately 1.9 V (=3.4-1.5). As is understood by comparing the charge/discharge plots of the lithium-ion secondary battery 400 with those of the lithium-ion secondary battery 100 of the above embodiment (see FIGS. 6 and 7), fluctuation in the voltage can be alleviated during the charging/discharging, by using not the carbon-based material but Li₄Ti₅O₁₂-based material as the negative-electrode active material when LiFePO₄ is used as the positive-electrode active material. Therefore, in the lithium-ion secondary battery 400 of modified example 3, stable output characteristics (IV characteristics) with small output fluctuation can be achieved.

Note that Li₄Ti₅O₁₂ has characteristics of being able to insert/emit Li ion in an amount equivalent to approximately 100% of the theoretical electric capacity at a charge/discharge potential (based on Li) of approximately 1.5 V. Therefore, in the lithium-ion secondary battery 400, the battery voltage at which the positive-electrode potential (based on Li) becomes at least 3.55 but not more than 4.05 V is at least 2.05 V but not more than 2.55 V. As shown in FIG. 11, electricity quantity equivalent to approximately 90% to 99% of the theoretical electric capacity can be accumulated in the lithium-ion secondary battery 400 by charging this battery until the inter-terminal voltage falls within a range of 2.05 V to 2.55 V (a value at which the positive-electrode potential based on Li falls within a range of 3.55 V to 4.05 V).

Therefore, in the lithium-ion secondary battery 400, sufficient amount of charged electricity can be secured while keeping the excellent low-temperature output characteristics and life characteristics, by setting the upper limit charging voltage at a value (at least 2.05 V but not more than 2.55 V) at which the positive-electrode potential (based on Li) becomes at least 3.55 V but not more than 4.05 V to perform charge control in the same manner as in the above embodiment (to perform the processing between steps S1 to S6 shown in FIG. 9).

What is claimed is:

1. A lithium-ion secondary battery, comprising:
a positive-electrode active material;
a negative-electrode active material; and
a nonaqueous electrolysis solution, wherein
the positive-electrode active material is LiFe_{(1-X)}M_{X}PO₄ (where M represents at least one of Mn, Cr, Co, Cu, Ni, V, Mo, Ti, Zn, Al, Ga, Mg, B and Nb, and where 0≦X≦0.5), and
the nonaqueous electrolysis solution contains an ester solvent represented by the following formula (1) where R1 represents an alkyl group having 1 to 4 hydrogen atoms or carbon atoms, and R2 an alkyl group having 1 to 4 carbon atoms:

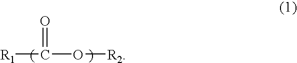

2. The lithium-ion secondary battery according to claim 1, wherein the ester solvent is at least one type of ester solvent selected from methyl formate, ethyl formate, methyl acetate, ethyl acetate, methyl propionate and ethyl propionate.

3. The lithium-ion secondary battery according to claim 1, wherein the negative-electrode active material is a carbon-based material.

4. An assembled battery, comprising:
a plurality of the lithium-ion secondary batteries according to claim 1, wherein
the plurality of lithium-ion secondary batteries are electrically connected in series with each other.

5. A hybrid automobile, comprising:
the assembled battery according to claim 4, wherein
the assembled battery is mounted in the hybrid automobile as a drive power source.

6. The hybrid automobile according to claim 5, wherein the ester solvent of each of the lithium-ion secondary batteries is at least one type of ester solvent selected from methyl formate, ethyl formate, methyl acetate, ethyl acetate, methyl propionate and ethyl propionate.

7. The hybrid automobile according to claim 5, wherein the negative-electrode active material of each of the lithium-ion secondary batteries is a carbon-based material.

8. A battery system, comprising:
the lithium-ion secondary battery according to claim 1;
charge starting means for starting charging the lithium-ion secondary battery; and
charge stopping means for stopping charging the lithium-ion secondary battery when an inter-terminal voltage of the lithium-ion secondary battery reaches a predetermined upper limit charging voltage value, wherein
the charge stopping means sets the upper limit charging voltage value at a value at which a positive-electrode potential based on lithium falls within a range of at least 3.55 V but not more than 4.05 V.

9. The battery system according to claim 8, wherein the upper limit charging voltage value is set at a value at which the positive-electrode potential based on lithium falls within a range of at least 3.55 V but not more than 3.85 V.

10. The battery system according to claim 8, wherein the ester solvent of the lithium-ion secondary battery is at least one type of ester solvent selected from methyl formate, ethyl formate, methyl acetate, ethyl acetate, methyl propionate and ethyl propionate.
